(19) United States
(12) Patent Application Publication
(10) Pub. No.: US 2025/0178594 A1
(43) Pub. Date: Jun. 5, 2025

(54) PARKING SUPPORT APPARATUS

(71) Applicant: TOYOTA JIDOSHA KABUSHIKI KAISHA, Aichi (JP)

(72) Inventor: Atsuko YAMADA, Toyota-shi (JP)

(21) Appl. No.: 18/954,535

(22) Filed: Nov. 21, 2024

(30) Foreign Application Priority Data
Nov. 30, 2023 (JP) 2023-202471

(51) Int. Cl. B60W 30/06; B60W 50/14

(52) U.S. Cl. CPC B60W 30/06; B60W 50/14

(57) ABSTRACT

A parking support apparatus executes an automatic parking control for making a vehicle travel automatically to a designated space designated by a user to park the vehicle in the designated space automatically. The parking support apparatus ends the automatic parking control when a predetermined end condition is satisfied. The parking support apparatus makes the vehicle travel automatically to search for an available space, when the parking support apparatus determines that the vehicle cannot park in the designated space while the vehicle travels automatically to the designated space. The parking support apparatus automatically parks the vehicle in the available space when the parking support apparatus finds the available space, and informs the user that there is no available space when the parking support apparatus finds no available space by a time at which the end condition is satisfied.

### TECHNICAL FIELD

The present disclosure relates to a parking support apparatus configured to execute an automatic parking control for automatically parking a vehicle in a designated space designated by a user.

### BACKGROUND

Conventionally, there has been known a parking support apparatus configured to perform an automatic parking control. For example, a driving support apparatus described in Patent Document 1 (hereinafter referred to as a “conventional apparatus”) is a management apparatus for an automatic valet parking lot, and is configured to communicate with multiple vehicles present in or around the parking lot. If a parking priority of a first vehicle that is about to park newly is higher than that of a second vehicle that is already parked, the conventional apparatus instructs the second vehicle to exit the parked parking space and instructs the first vehicle to park in that parking space.
Patent Document 1: Japanese Patent Application Laid-Open No. 2020-077064

### SUMMARY

The conventional apparatus is assumed to be able to control the multiple vehicles by giving instructions to the multiple vehicles. The conventional apparatus cannot be applied to a parking support apparatus configured to control only one vehicle. That is, “a parking support apparatus configured to control only one vehicle” cannot make the second vehicle exit a designated space designated by a user and in which the first vehicle is about to park newly.

The present disclosure is made to address the above problem. That is, one of the objects of the present disclosure is to provide a parking support apparatus can park a vehicle without bothering the user when the vehicle cannot park in the designated space.

A parking support apparatus according to the present disclosure (hereinafter, referred to as the “present disclosure apparatus”) is configured to execute an automatic parking control for making a vehicle travel automatically to a designated space (DS) designated by a user to park the vehicle in the designated space automatically (steps 600 through 695).

The parking support apparatus is configured to;
end the automatic parking control (step 560, step 565) when a predetermined end condition is satisfied (“Yes” at step 530);
make the vehicle travel automatically to search for an available space in which the vehicle can park (step 664, step 670, step 672), when the parking support apparatus determines that the vehicle cannot park in the designated space while the vehicle travels automatically to the designated space (“Yes” at step 635);
automatically park the vehicle in the available space (step 676, step 678, step 680) when the parking support apparatus finds the available space (“Yes” at step 672); and
inform the user that there is no available space (step 570) when the parking support apparatus finds no available space by a time at which the end condition is satisfied (“Yes” at step 530, “Yes” at step 548, “No” at step 550).

According to the present disclosure apparatus, if the vehicle cannot park in the designated space, the vehicle searches for the available space and automatically parks in the available space. Therefore, the vehicle can park without bothering the user. Furthermore, if no available space is found by the time at which the end condition is satisfied, the user is notified of this fact. Accordingly, the user can take an action such as designating a new parking space.

### BRIEF DESCRIPTION OF THE DRAWINGS

FIG. 1 is a schematic system configuration diagram of a parking support system according to an embodiment of the present disclosure.

FIG. 2 is a sequence diagram for an operation of the parking support system according to the embodiment of the present disclosure.

FIG. 3 is a drawing for illustrating an operation example of a parking support apparatus shown in FIG. 1.

FIG. 4 is a flowchart illustrating a start determination routine executed by a CPU of an ECU shown in FIG. 1.

FIG. 5 is a flowchart illustrating a stop determination routine executed by the CPU of the ECU shown in FIG. 1.

FIG. 6 is a flowchart illustrating a part of a reverse summon control routine executed by the CPU of the ECU shown in FIG. 1.

FIG. 7 is a flowchart illustrating the rest of the reverse summon control routine executed by the CPU of the ECU shown in FIG. 1.

### DETAILED DESCRIPTION

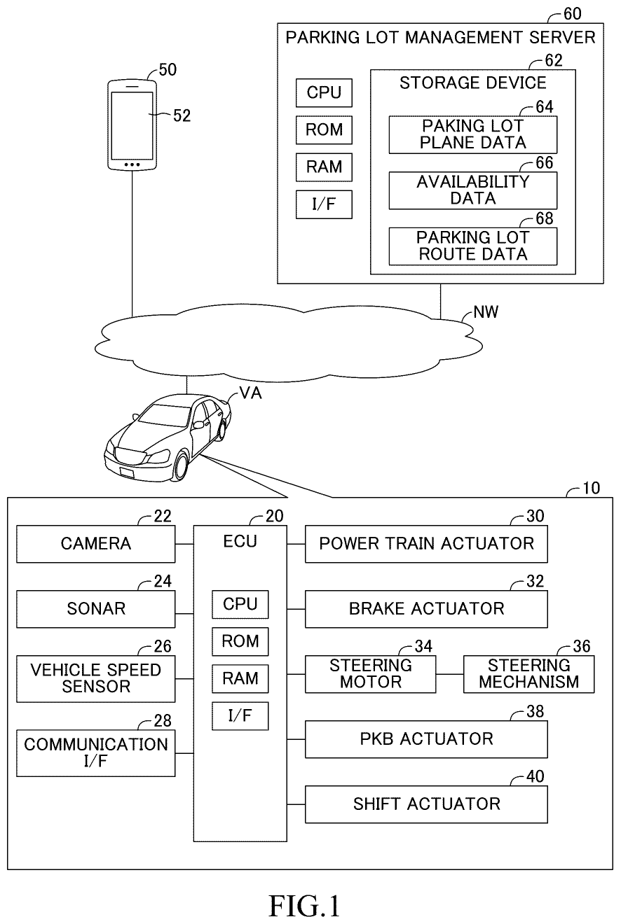

As shown in FIG. 1, a parking support system comprises a parking support apparatus 10 applied to a vehicle VA, a remote operation apparatus 50, and a parking lot management server 60. The parking support apparatus 10, the remote operation apparatus 50, and the parking lot management server 60 are communicatively connected via a network NW.

The parking support apparatus 10 comprises components shown in FIG. 1. In this specification, the “ECU 20” is an electronic control unit with a microcomputer as a main part. The ECU 20 is also referred to as a control unit, a controller and a computer. The microcomputer includes a CPU (processor), a ROM, a RAM, and an interface (I/F), etc. Functions realized by the ECU 20 may be realized by multiple ECUs.

A camera 22 acquires image data by capturing a scenery around the vehicle VA. The ECU 20 acquires image data from the camera 22.

A sonar 24 acquires sonar data about a position of an object around the vehicle VA with respect to the vehicle VA. The ECU 20 acquires the sonar data from the sonar 24. A wheel speed sensor 26 measures a wheel speed of each of wheels. The ECU 20 acquires the measured values from the wheel speed sensor 26. A communication interface (I/F) 28 is an interface for connecting to the network NW.

A power train actuator 30 changes a driving force generated by a drive device (e.g., an internal combustion engine and/or an electric motor) of the vehicle VA. A brake actuator 32 controls a braking force applied to the vehicle VA. A steering motor 34 is incorporated into a steering mechanism 36. The steering mechanism 36 is a mechanism for turning steered wheels in response to an operation on a steering wheel. The steering motor 34 generates an automatic steering torque in the steering mechanism 36 to change a steered angle of the steered wheels in response to an instruction from the ECU 20.

A PKB actuator 38 applies a parking brake force to the wheels. The ECU 20 can keep the vehicle VA stopped by applying the parking brake force to the wheels using the PKB actuator 38. A shift actuator 40 changes a shift range. The shift range is set to one of a parking range (P), a forward range (D), a reverse range (R), and the like.

The remote operation apparatus 50 is an apparatus that can be operated by a user outside the vehicle VA. For example, the remote operation apparatus 50 is a smartphone. The remote operation apparatus 50 comprises a display device 52. The display device 52 is a touch panel type. The user can input data to the remote operation apparatus 50 by touching the display device 52. If the display device 52 is not the touch panel type, the remote operation apparatus 50 comprises an input device.

A parking lot management server 60 is a server configured to manage availability of parking spaces in a parking lot. The parking lot management server 60 comprises a CPU, a ROM, a RAM, and an interface (I/F). Furthermore, the parking lot management server 60 comprises a storage device 62. Parking lot plane data 64, availability data 66, and parking lot route data 68 are stored in the storage device 62. The parking lot plane data 64 is data about a plane view of the parking lot. The availability data 66 is data about the availability of the parking spaces in the parking lot. The parking lot management server 60 specifies the availability of the parking spaces based on images taken by cameras which are installed in the parking lot and captures images of the parking spaces. The parking lot management server 60 updates the availability data 66 based on the specified availability. The parking lot route data 68 is data about routes that the vehicle VA can travel in the parking lot.

### (Outline of Operation)

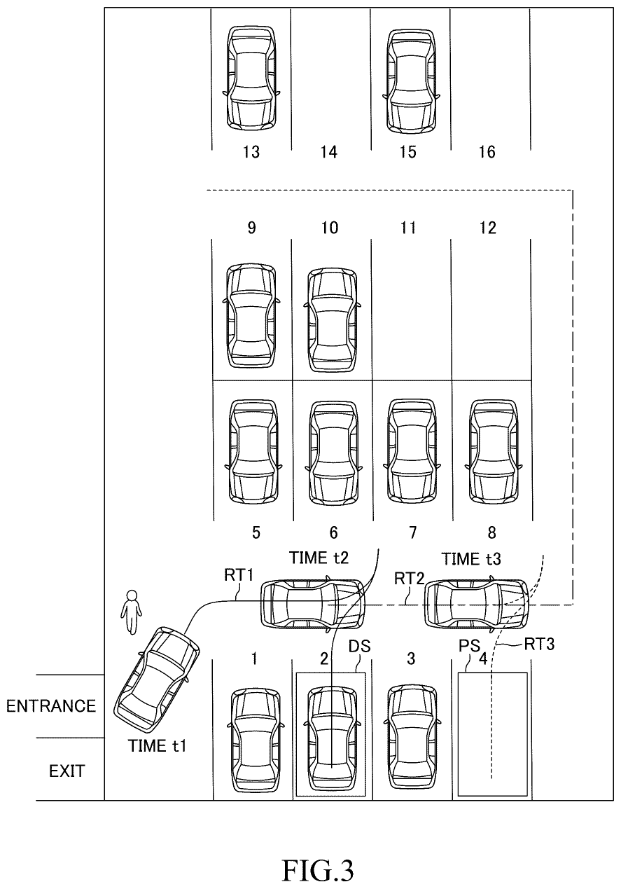

The parking support apparatus 10 according to the present embodiment executes an automatic parking control. In the automatic parking control, the ECU 20 makes the vehicle travel automatically to a designated space DS (referring to FIG. 3). The designated space DS is a parking space designated by the user. The user designates the parking space by operating the remote operation apparatus 50. An example of such automatic parking control is a reverse summon control, which is a type of automatic driving. In the reverse summon control, the user gets out of the vehicle VA at an entrance of the parking lot to operate the remote operation apparatus 50, and the ECU 20 makes the vehicle VA travel automatically (autonomously) to the designated space DS and parks in the designated space DS in response to the user's operation of the remote operation apparatus 50.

If the user designates the parking space in which another vehicle already parks as the designated space DS, or if another vehicle parks in the designated space DS while the vehicle VA is traveling to the designated space DS, the vehicle VA may be unable to park in the designated space DS. If the user needs to designate a new designated space DS when the vehicle VA cannot park in the designated space DS, the user may feel that it is bothersome to designate the new designated space DS.

Therefore, if the parking support apparatus 10 determines that the vehicle VA cannot park in the designated space DS, the parking support apparatus 10 searches for a parking space where the vehicle can park (hereinafter referred to as an “available space PS”). In detail, the parking support apparatus 10 makes the vehicle VA travel automatically to search for the available space PS. When the parking support apparatus 10 finds the available space PS, the parking support apparatus 10 automatically parks the vehicle VA in the available space PS.

Thus, even if the vehicle VA cannot park in the designated space DS, the user does not need to designate the new designated space DS. Accordingly, the present embodiment can reduce a possibility that the user feel that it is bothersome to designate the new designated space DS.

### (Operation)

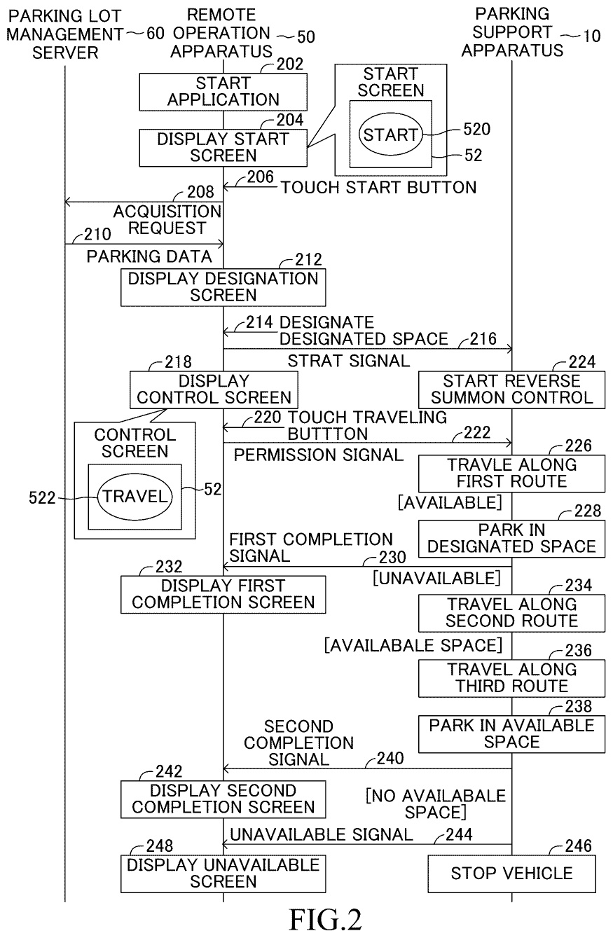

Referring to FIG. 2, an operation of the parking support system is described.

The user starts a parking support application on the remote operation apparatus 50 (202). When the parking support application is started, the remote operation apparatus 50 displays a start screen that includes a start button 520 on the display device 52 (204). When the user touches the start button 520 (206), the remote operation apparatus 50 identifies the parking lot management server 60 of the parking lot closest to the current position of the vehicle VA and transmits an acquisition request to the parking lot management server 60 (208). The remote operation apparatus 50 stores location data in which the correspondence between a location of the parking lot managed by the parking lot management server 60 and an identifier of the parking lot management server 60 is registered. The current position of the vehicle VA is identified based on signals received by a Global Navigation Satellite System (GNSS) receiver (not shown). The parking support apparatus 10 comprises the GNSS receiver.

When the parking lot management server 60 receives the acquisition request, the parking lot management server 60 transmits parking data including the parking lot plane data 64, the availability data 66, and the parking route data 68 to the remote operation apparatus 50 (210). When the remote operation apparatus 50 receives the parking data, the remote operation apparatus 50 displays a designation screen on the display device 52 based on the parking space plane data 64 and the availability data 66 (212). The designation screen is a screen for the user to designate the designated space DS. The designation screen displays the plane view of the parking lot and the availability of each parking space in the parking lot.

When the user designates the designated space DS on the designation screen (214), the remote operation apparatus 50 transmits a start signal to the parking support apparatus 10 (216) and displays a control screen including a travel button 522 on the display device 52 (218). The start signal includes data about a position of the designated space DS in the plane view of the parking lot plane data 64 and the parking route data 68. While the user is touching the travel button 522 (220), the remote operation apparatus 50 transmits a permission signal to the parking support apparatus 10 every time a predetermined time elapses (222).

When the parking support apparatus 10 receives the start signal, the parking support apparatus 10 starts the reverse summon control (224). In detail, the parking support apparatus 10 generates a first route RT1 (referring to FIG. 3) from the current position of the vehicle VA to the designated space DS for the vehicle VA to park in the designated space DS. If the parking support apparatus 10 receives the permission signal, the parking support apparatus 10 makes the vehicle VA travel automatically along the first route RT1 (226). Specifically, the parking support apparatus 10 controls the power train actuator 30, the brake actuator 32, and the steering motor 34 so that the vehicle VA travels along the first route RT1. If a time period during which the parking support apparatus 10 does not receive the permission signal is equal to or longer than a certain time period, the parking support apparatus 10 cancels the vehicle VA from traveling automatically and stops the vehicle VA.

The parking support apparatus 10 determines whether or not the designated space DS is available for parking based on the image data and the sonar data while the vehicle VA is automatically traveling along the first route RT1. When the vehicle VA reaches the vicinity of the designated space DS, the parking support apparatus 10 can determine whether or not the designated space DS is available for parking. Similarly, the parking support apparatus 10 searches for the available space PS based on the image data and the sonar data. If the parking support apparatus 10 finds the available space PS, the parking support apparatus 10 stores a position of the available space PS.

If the parking support apparatus 10 determines that the designated space DS is available for parking when the vehicle VA reaches the vicinity of the designated space DS, the parking support apparatus 10 continues to make the vehicle VA travel along the first route RT1 and park the vehicle VA in the designated space DS (228). Specifically, the parking support apparatus 10 controls the power train actuator 30, the brake actuator 32, and the steering motor 34 so that the vehicle VA parks in the designated space DS. When the vehicle VA has completed parking in the designated space DS, the parking support apparatus 10 activates the PKB actuator 38 to keep the vehicle VA stopped and controls the shift actuator 40 to change the shift range to the parking range (P). When the vehicle VA has completed parking in the designated space DS, the parking support apparatus 10 transmits a first completion signal to the remote operation apparatus 50 (230). When the remote operation apparatus 50 receives the first completion signal, the remote operation apparatus 10 displays a first completion screen on the display device 52 (232). The first completion screen is a screen for informing the user that the vehicle VA has parked in the designated space DS.

On the other hand, in a case where the parking support apparatus 10 determines that the designated space DS is not available for parking when vehicle VA reaches the vicinity of designated space DS, and if no available space PS has been found, the parking support apparatus 10 generates a second Route RT2 (referring to FIG. 3) based on the parking route data 68. The parking support apparatus 10 makes the vehicle VA travel along the second route RT2 to search for the available space PS (234). In detail, the parking support apparatus 10 controls the power train actuator 30, the brake actuator 32, and the steering motor 34 so that the vehicle VA travels along the second route RT2.

If the parking support apparatus 10 finds the available space PS before an end condition is satisfied, the parking support apparatus 10 generates a third route PT3 (referring to FIG. 3) from the current position of the vehicle VA to the available space PS for the vehicle VA to park in the available space PS. The end condition is satisfied when a travel distance D from a start time at which the reverse summon control is started is equal to or longer than a threshold distance Dth. The parking support apparatus 10 makes the vehicle VA travel along the third route RT3 (236) and parks the vehicle VA in the available space PS (238). When the vehicle has completed parking in the available space PS, the parking support apparatus 10 transmits a second completion signal to the remote operation apparatus 50 (240). When the remote operation apparatus 50 receives the second completion signal, the remote operation apparatus 50 displays a second completion screen on the display apparatus 52 (242). The second completion screen is a screen for informing the user that the vehicle VA has parked in the available space PS because the vehicle VA cannot park in the designated space DS, and the position of the available space PS where the vehicle VA has parked.

If the parking support apparatus 10 cannot find the available space PS by a time at which the end condition is satisfied, the parking support apparatus 10 transmits an unavailable signal to the remote operation apparatus 50 (244) and stops the vehicle VA (246). When the remote operation apparatus 50 receives the unavailable signal (a second unavailable signal described below), the remote operation apparatus 50 displays an unavailable screen (a second unavailable screen described below) on the display device 52 (248). The unavailable screen is a screen for informing the user that the vehicle VA cannot park in the designated space DS and that no available space PS cannot be found.

### Operation Example

Referring to FIG. 3, an operation example of the parking support apparatus 10 is described. As shown in FIG. 3, there are parking spaces No. 1 through No. 16 in the parking lot.

At time t1, the user gets out of the vehicle VA, operates the remote operation apparatus 50 to start the parking support application, and designates the parking space No. 2 as the designated space DS. When the designated space DS is designated, the parking support apparatus 10 starts the reverse summon control, and generates the first route RT1 (referring to a solid line RT1 in FIG. 3) from the current position of the vehicle VA to the designated space DS.

The parking support apparatus 10 makes the vehicle VA travel along the first route RT1. At time t2, the vehicle VA reaches in front of the designated space DS. At time t2, the parking support apparatus 10 determines that the vehicle VA cannot park in the designated space DS because another vehicle is parked in the designated space DS. In this case, the parking support apparatus 10 generates the second route RT2 (referring to a dotted line RT2 in FIG. 3) to search for the available space PS.

The parking support apparatus 10 makes the vehicle VA travel along the second route RT2. At time t3, the vehicle VA reaches in front of parking space No. 4. In this case, the parking support apparatus 10 determines that parking space No. 4 is the available space PS, and the generates the third route RT3 (referring to a dotted line RT3 in FIG. 3) to park vehicle VA in the available space PS.

The parking support apparatus 10 can park the vehicle VA in parking space No. 4 which is the available space PS, by making the vehicle VA travel along the third route RT3.

### (Specific Operation)

The CPU of the ECU 20 executes routines shown by flowcharts in FIGS. 3 through 6 every time a predetermined time elapses.

### <Start Determination Routine>

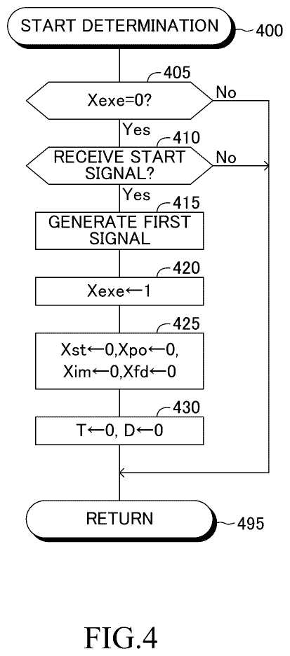

When an appropriate time point comes, the CPU starts a process from step 400 in FIG. 4 and the process proceeds to step 405. At step 405, the CPU determines whether or not a value of an execution flag Xexe is “0”.

The value of the execution flag Xexe is set to “1” when the reverse summon control is started, and is set to “0” when the reverse summon control is ended. The value of the execution flag Xexe is set to “0” in an initialization routine. The initialization routine is executed by the CPU when an ignition key switch (not shown) of the vehicle VA is changed from an off position to an on position.

If the value of the execution flag Xexe is “0”, the CPU makes a “Yes” determination at step 405 and the process proceeds to step 410. At step 410, the CPU determines whether or not the parking support apparatus 10 has received the start signal from the remote operation apparatus 50.

If the parking support apparatus 10 has not received the start signal, the CPU makes a “No” determination at step 410. In this case, the process proceeds to step 495 and the CPU terminates the present routine tentatively. On the other hand, if the parking support apparatus 10 has received the start signal, the CPU executes steps 415 through 430 in sequence.

Step 415: The CPU generates the first route RT1.

Step 420: The CPU sets the value of the execution flag Xexe to “1”.

Step 425: The CPU sets the value of a stop flag Xst, an available flag Xpo, an unavailable flag Xim and a finding flag Xfd to “0”.

The stop flag Xst is set to “1” when the time period during which no permission signal is received equal to or longer than the certain time period, and is set to “0” when the permission signal is received. The available flag Xpo is set to “1” when the designated space DS is available for parking, and is set to “0” when the designated space DS is not available for parking. The unavailable flag Xim is set to “1” when the designated space DS is not available for parking, and is set to “0” when the designated space DS is available for parking. The finding flag Xfd is set to “1” when the designated space DS is not available for parking and the available space PS is found.

These flags are set to “0” in the initialization routine.

Step 430: The CPU sets a timer T and a travel distance D to “0”.

The timer T is a timer for counting the time period during which no permission signal is received. The travel distance D represents the distance that the vehicle VA has traveled from the start time point at which the reverse summon control is started.

Thereafter, the process proceeds to step 495 and the CPU terminates the present routine tentatively.

If the value of the execution flag Xexe is “1” when the process proceeds to step 405, the CPU makes a “No” determination at step 405. In this case, the process proceeds to step 495 and the CPU terminates the present routine tentatively.

### <Stop Determination Routine>

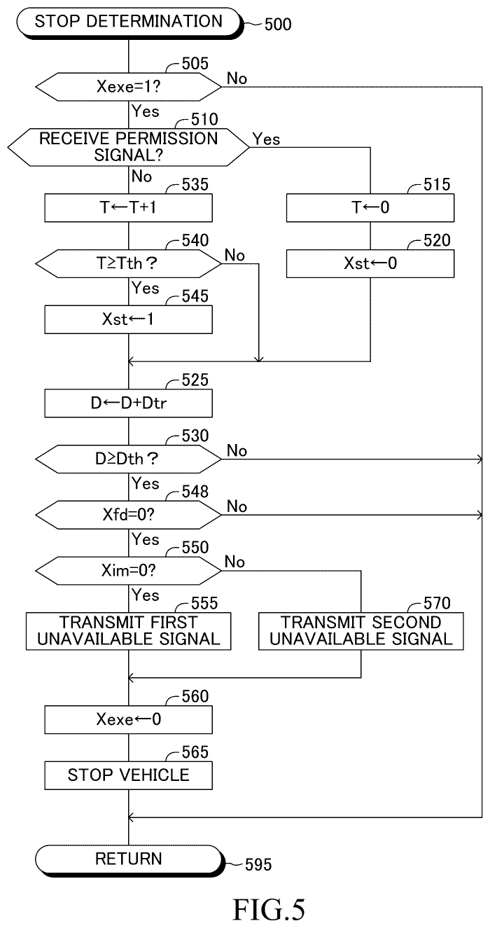

When an appropriate time point comes, the CPU starts a process from step 500 in FIG. 5 and the process proceeds to step 505. At step 505, the CPU determines whether or not the value of the execution flag Xexe is “1”.

If the value of the execution flag Xexe is “0”, the CPU makes a “No” determination at step 505. In this case, the process proceeds to step 595 and the CPU terminates the present routine tentatively. If the value of the execution flag Xexe is “1”, the CPU makes a “Yes” determination at step 505 and the process proceeds to step 510. At step 510, the CPU determines whether or not the parking support apparatus 10 receives the permission signal.

If the parking support apparatus 10 receives the permission signal, the CPU makes a “Yes” determination at step 510 and executes steps 515 through 530.

Step 515: The CPU sets the timer T to “0”.

Step 520: The CPU sets the value of the stop flag Xst to “0”.

Step 525: The CPU adds a travel distance Dtr traveled by the vehicle VA from a time at which the present routine was last executed to the present time to the travel distance D. The travel distance Dtr is specified based on the detected value of the wheel speed sensor 26.

Step 530: The CPU determines whether or not the travel distance D is equal to or longer than the threshold distance Dth.

If the travel distance D is shorter than the threshold distance Dth, the CPU makes a “No” determination at step 530. In this case, the process proceeds to step 595 and the CPU terminates the present routine tentatively.

If the parking support apparatus 10 does not receive the permission signal when the process proceeds to step 510, the CPU makes a “No” determination at step 510 and executes step 535 and step 540.

Step 535: The CPU adds “1” to the timer T.

Step 540: The CPU determines whether or not the timer T is equal to or greater than a threshold value Tth.

If the timer T is smaller than the threshold Tth, the CPU makes a “No” determination at step 540 and the process proceeds to step 525. If the timer T is equal to greater than the threshold value Tth, the CPU makes a “Yes” determination at step 540, and the process proceeds to step 545. At step 545, the CPU sets the value of the stop flag Xst to “1” and the process proceeds to step 525.

If the travel distance D is equal to or greater than the threshold distance Dth when the process proceeds to step 530, the CPU makes a “Yes” determination at step 530 and the process proceeds to step 548. At step 548, the CPU determines whether or not the value of the finding flag Xfd is “0”.

If the value of the finding flag Xfd is “0”, the CPU makes a “Yes” determination at step 548 and the process proceeds to step 550. At step 550, the CPU determines whether or not the value of the unavailable flag Xim is “0”.

If the value of the unavailable flag Xim is “0”, the CPU makes a “Yes” determination at step 550 and executes steps 555 through 565.

Step 555: The CPU transmits a first unavailable signal to the remote operation apparatus 50.

When the remote operation apparatus 50 receives the first unavailable signal, the remote operation apparatus 50 displays a first unavailable screen on the display device 52. The first unavailable screen is a screen for informing the user that the vehicle VA cannot complete parking in the designated space DS.

Step 560: The CPU sets the value of the execution flag Xexe to “0”.

Step 565: The CPU decelerates the vehicle VA to stop the vehicle VA. When the vehicle VA stops, the CPU activates the PKB actuator 38 to keep the vehicle VA stopped and controls the shift actuator 40 to change the shift range to the parking range (P).

Thereafter, the process proceeds to step 595 and the CPU terminates the present routine tentatively.

If the value of the unavailable flag Xim is “1” when the process proceeds to step 550, the CPU makes a “No” determination at step 550 and the process proceeds to step 570. At step 570, the CPU transmits the second unavailable signal to the remote operation apparatus 50. Thereafter, the process proceeds to step 560. When the remote operation apparatus 50 receives the second unavailable signal, the remote operation apparatus 50 displays the second unavailable screen on the display device 52. The second unavailable screen is a screen for informing the user that the vehicle VA cannot park in the designated space DS and that there is no available space PS.

If the value of the finding flag Xfd is “1” when the process proceeds to step 548, the CPU makes a “No” determination at step 548. In this case, the process proceeds to step 595 and the CPU terminates the present routine tentatively. If the designated space DS is unavailable for parking and the available space PS is found, the value of the finding flag Xfd is set to “1”. In this case, even if the end condition is satisfied (“Yes” at step 530) after the value of the finding flag Xfd is set to “1” (after the available space PS is found), the value of the execution flag Xexe is not set to “0” (the remote summon control does not end) and the vehicle VA parks in the available space PS. This reduces a possibility that the vehicle VA stops on a path route that vehicles can travel in the parking lot.

### <Reverse Summon Control Routine>

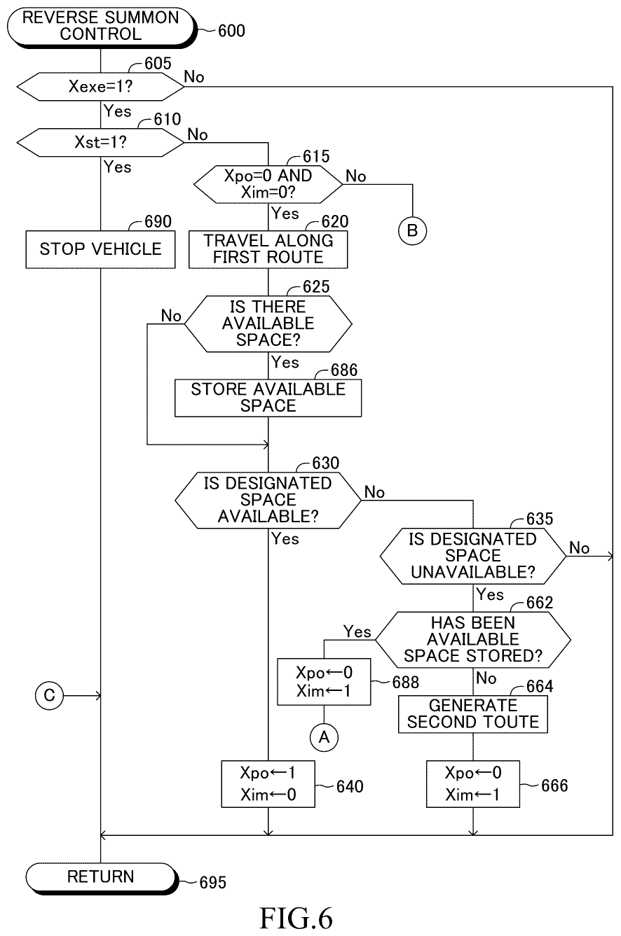

When an appropriate time point comes, the CPU starts a process at step 600 in FIG. 6 and the process proceeds to step 605. At step 605, the CPU determines whether or not the value of the execution flag Xexe is “1”.

If the value of the execution flag Xexe is “0”, the CPU makes a “No” determination at step 605. In this case, the process proceeds to step 695 and the CPU terminates the present routine tentatively. If the value of the execution flag Xexe is “1”, the CPU makes a “Yes” determination at step 605 and the process proceeds to step 610. At step 610, the CPU determines whether or not the value of the stop flag Xst is “1”.

If the value of the stop flag Xst is “0”, the CPU makes a “No” determination at step 610 and the process proceeds to step 615. At step 615, the CPU determines whether or not the value of the available flag Xpo and the unavailable flag Xim are both “0”.

If the values of the available flag Xpo and the unavailable flag Xim are both “0”, the CPU makes a “Yes” determination at step 615 and executes steps 620 and 625.

Step 620: The CPU controls the vehicle VA so that the vehicle VA travels along the first route RT1.

Step 625: The CPU determines whether or not there is the available space PS based on the image data and the sonar data.

If there is no available space PS, the CPU makes a “No” determination at step 625 and the process proceeds to step 630. At step 630, the CPU determines whether or not the designated space DS is available for parking based on the image data and the sonar data.

If the designated space DS is unavailable for parking or if the CPU cannot determine whether the designated space DS is available or unavailable for parking, the CPU makes a “No” determination at step 630 and the process proceeds to step 635. At step 635, the CPU determines whether or not the designated space DS is unavailable for parking.

If the CPU cannot determine whether the designated space DS is available or unavailable for parking, the CPU makes a “No” determination at step 635. In this case, the process proceeds to step 695 and the CPU terminates the present routine tentatively.

If the designated space DS is available for parking when the process proceeds to step 630, the CPU determines “Yes” at step 630 and the process proceeds to step 640. At step 640, the CPU sets the value of the available flag Xpo to “1” and the value of the unavailable flag Xim to “0”. Thereafter, the process proceeds to step 695 and the CPU terminates the present routine tentatively.

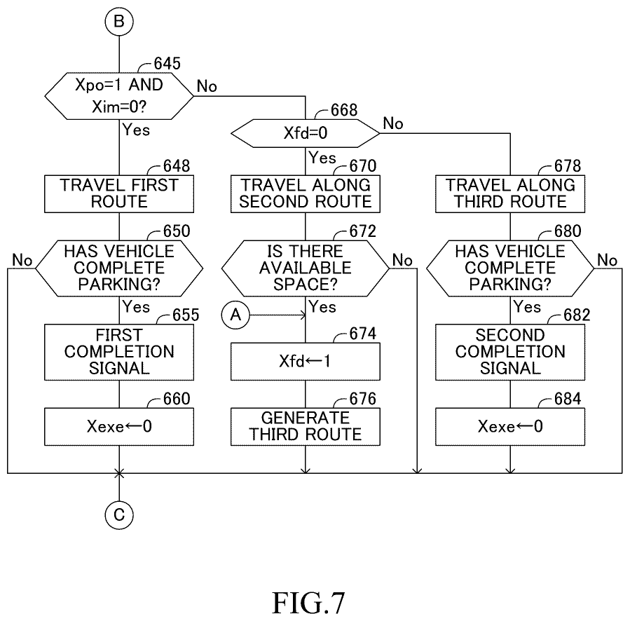

If the value of the available flag Xpo is “1” and the value of the unavailable flag Xim is “0” when the process proceeds to step 615, the CPU makes a “No” determination at step 615 and the process proceeds to step 645 shown in FIG. 7. At step 645, the CPU determines whether or not the value of the available flag Xpo is “1” and the value of the unavailable flag Xim is “0”. Since the value of the available flag Xpo is “1” and the value of the disable flag Xim is “0”, the CPU makes a “Yes” determination at step 645 and executes steps 648 and 650.

Step 648: The CPU controls the vehicle VA so that the vehicle VA travels along the first route RT1.

Step 650: The CPU determines whether or not the vehicle has completed parking in the designated space DS.

If the vehicle VA has not completed parking in the designated space DS, the CPU makes a “No” determination at step 650. In this case, the process proceeds to step 695 shown in FIG. 6 and the CPU terminates the present routine tentatively.

If the vehicle VA has completed parking in the designated space DS, the CPU makes a “Yes” determination at step 650 shown in FIG. 7 and executes steps 655 and 660.

Step 655: The CPU transmits the first completion signal to the remote operation apparatus 50.

Step 660: The CPU sets the value of the execution flag Xexe to “0”.

Thereafter, the process proceeds to step 695 shown in FIG. 6 and the CPU terminates the present routine tentatively.

If the designated space DS is unavailable for parking when the process proceeds to step 635 shown in FIG. 6, the CPU makes a “Yes” determination at step 635 and the process proceeds to step 662. At step 662, the CPU determines whether or not the available space PS has been stored.

If no available space PS has been stored, the CPU makes a “No” determination at step 662 and executes steps 664 and 666.

Step 664: The CPU generates the second route RT2.

Step 666: The CPU sets the value of the available flag Xpo to “0” and the value of the unavailable flag Xim to “1”.

Thereafter, the process proceeds to step 695 and the CPU terminates the present routine tentatively.

If the value of the available flag Xpo is “0” and the value of the unavailable flag Xim is “1” when the process proceeds to step 645 shown in FIG. 7, the CPU makes a “No” determination at step 645 and the process proceeds to step 668. At step 668, the CPU determines whether or not the value of the finding flag Xfd is “0”.

If the value of the finding flag Xfd is “0”, the CPU makes a “Yes” determination at step 668 and executes steps 670 and 672.

Step 670: The CPU controls the vehicle VA so that the vehicle VA travels along the second route RT2.

Step 672: The CPU determines whether or not there is the available space PS based on the image data and the sonar data.

If there is no available space PS, the CPU makes a “No” determination at step 672. In this case, the process proceeds to step 695 shown in FIG. 6 and the CPU terminates the present routine tentatively. If there is the available space PS, the CPU makes a “Yes” determination at step 672 shown in FIG. 7 and executes steps 674 and 676.

Step 674: The CPU sets the value of the finding flag Xfd to “1”.

Step 676: The CPU generates the third route RT3.

Thereafter, the process then proceeds to step 695 shown in FIG. 6 and the CPU terminates the present routine tentatively.

If the value of the finding flag Xfd is “1” when the process proceeds to step 668 shown in FIG. 7, the CPU makes a “No” determination at step 668 and executes steps 678 and 680.

Step 678: The CPU controls the vehicle VA so that the vehicle VA travels along the third route RT3.

Step 680: The CPU determines whether or not the vehicle VA has completed parking in the available space PS.

If the vehicle VA has not completed parking in the available space PS, the CPU makes a “No” determination at step 680. In this case, the process proceeds to step 695 shown in FIG. 6 and the CPU terminates the present routine tentatively.

When the vehicle has completed parking in the available space PS, the CPU makes a “Yes” determination at step 680 shown in FIG. 7 and executes steps 682 and 684.

Step 682: The CPU transmits the second completion signal to the remote operation apparatus 50.

Step 684: The CPU sets the value of the execution flag Xexe to “0”.

Thereafter, the process proceeds to step 695 shown in FIG. 6 and the CPU terminates the present routine tentatively.

The CPU determines whether or not there is the available space PS (referring to step 625) even before the CPU determines that the designated space DS is unavailable for parking. If there is the available space PS when the process proceeds to step 625, the CPU makes a “Yes” determination at step 625 and the process proceeds to step 686. At step 686, the CPU stores the available space PS. Thereafter, the process proceeds to step 630.

If the designated space DS is unavailable for parking when the process proceeds to step 635, the CPU makes a “Yes” determination at step 635 and the process proceeds to step 662. If the available space PS has been stored, the CPU makes a “Yes” determination at step 662 and the process proceeds to step 688. At step 688, the CPU sets the value of the available flag Xpo to “0” and the value of the unavailable flag Xim to “1”. Thereafter, the CPU executes steps 674 and 676 shown in FIG. 7. The CPU sets the value of the finding flag Xfd to “1” and generates the third route RT3.

According to the present embodiment, if the designated space DS is unavailable for parking (“Yes” at step 635 shown in FIG. 6), the vehicle VA searches for the available space PS while traveling along the second route RT2 (steps 670 and 672). If there is the available space PS (“Yes” at step 668), the vehicle VA parks in the available space PS while traveling along the third route RT3 (step 678). The parking support apparatus 10 can park the vehicle VA in another space without bothering the user, even if the designated space DS is unavailable for parking.

If no available space PS can be found when the end condition is satisfied, the display device 52 of the remote operation apparatus 50 displays the second unavailable screen (step 570). Accordingly, the parking support apparatus 10 can inform the user that the designated space DS is unavailable for parking and that there is no available space PS.

Furthermore, the end condition is satisfied when the travel distance D is equal to or longer than the threshold distance Dth so that the vehicle VA stops. Accordingly, a possibility that the vehicle VA travels autonomously to a position beyond the user's sight can be reduced.

Furthermore, if the parking support apparatus 10 finds the available space PS while the vehicle VA is traveling to the designated space DS, the parking support apparatus 10 stores the position of the available space PS. If the designated space DS is unavailable for parking, the vehicle VA parks in that available space PS. This increases a probability that the vehicle VA can park in the available space PS when the designated space DS is unavailable for parking.

Although the above embodiments were described using the reverse summon control as an example, the present disclosure can apply to any parking support control that allows the user to get out of the vehicle and park the vehicle VA in the designated space DS.

The parking support apparatus 10 may be applied to (or installed in/on) an engine vehicle, a hybrid electric vehicle (HEV), a plug-in hybrid electric vehicle (PHEV), a fuel cell electric vehicle (FCEV), and a battery electric vehicle (BEV).

What is claimed is:

1. A parking support apparatus configured to execute an automatic parking control for making a vehicle travel automatically to a designated space designated by a user to park the vehicle in the designated space automatically,
wherein,
the parking support apparatus is configured to;
end the automatic parking control when a predetermined end condition is satisfied;
make the vehicle travel automatically to search for an available space in which the vehicle can park, when the parking support apparatus determines that the vehicle cannot park in the designated space while the vehicle travels automatically to the designated space;
automatically park the vehicle in the available space when the parking support apparatus finds the available space; and
inform the user that there is no available space when the parking support apparatus finds no available space by a time at which the end condition is satisfied.

2. The parking support apparatus according to claim 1,
wherein,
the parking support apparatus is configured to:
search the available space, even before the parking support apparatus determines that the vehicle cannot park in the designated space; and
automatically park the vehicle in the available space, if the parking support apparatus finds the available space when the parking support apparatus determines that the vehicle cannot park in the designated space.

3. The parking support apparatus according to claim 1,
wherein,
the parking support apparatus is configured to determine that the end condition is satisfied when a travel distance that the vehicle has traveled from a start point at which the automatic parking control is started is equal to or longer than a threshold distance.

4. The parking support apparatus according to claim 1,
wherein,
the parking support apparatus is configured to park the vehicle in the available space without ending the automatic parking control, when the end condition is satisfied during a time period from a time at which the parking support apparatus finds the available space to a time at which the vehicle completes parking in the available space.
